(19) United States
(12) Patent Application Publication
(10) Pub. No.: US 2016/0124124 A1
(43) Pub. Date: May 5, 2016

(54) OPTIC APPARATUS

(71) Applicant: Sunmoon University Industry-University Cooperation, Asan-si (KR)

(72) Inventor: Kuk Won KO, Seongnam-si (KR)

(73) Assignee: SUNMOON UNIVERSITY INDUSTRY-UNIVERSITY COOPERATION, Asan-si (KR)

(21) Appl. No.: 14/527,102

(22) Filed: Oct. 29, 2014

(51) Int. Cl. G02B 3/00; G02B 6/32

(52) U.S. Cl. CPC G02B 3/0006; G02B 6/32

(57) ABSTRACT

The present invention relates to an optic apparatus, the optic apparatus including an optical pattern unit configured to output an optical pattern, and a conversion unit configured to reduce and output the optical pattern by receiving the optical pattern. The present invention relates to an optic apparatus, the optic apparatus including an optical pattern unit configured to align a plurality of lenses in parallel on a same line perpendicular to an optical path, and an optical conversion unit configured to include a plurality of optical fibers, each optical fiber being different in an area of cross-section at both distal ends, whereby the size of lenses is greater than that of a conventional lens to enable obtainment of greater quantity of light over that of a conventional MLA, and it is easier to align a pinhole positioned at a focus of a lens.

### FIELD

The present invention relates to an optic apparatus, and more particularly to an MLA (Multi Lens Array) optic apparatus.

### BACKGROUND

When curves or bends existing on the surfaces of samples such as semiconductor wafers, electronic substrates and steel plates have any effects on the properties of products, there is a need to measure the curves or the bends of relevant products.

For example, when laser beam is projected on a sample as an inspection object, using a laser distance measurement sensor, and a distance between the measurement sensor and the object is measured by receiving a laser beam reflected from the object, and if the measured distance is constant, it may be determined that the object is flat.

However, when the laser distance measurement sensor is used, there is a disadvantage in that it is very expensive to install the laser distance measurement sensor, and a control is required to move the laser distance measurement sensor for application to a broader scope.

Another disadvantage is that inspection time is lengthened, because a small number of laser distance measurement sensors are used to inspect an object. As a conventional apparatus for inspecting a surface of an object, Korea Registered Patent Publication No.: 0564323 is disclosed with a technique to measure a bend generated on an object, using a laser distance measurement sensor. However, the Korea Registered Patent Publication No.: 0564323 is still fraught with the limitations possessed by the laser distance measurement sensor.

### PRIOR ART

### Patent Document

(Patent Document 1): Korea Registered Patent Publication No.: 1010427070000

### DISCLOSURE

### Subjects

The present invention is to provide an optic apparatus configured to more easily array lenses than a conventional micro-sized MLA (Multi Lens Array) and to obtain an increased quantity of light by mounting an optical element configured to output an optical pattern without any bias by reducing the optical pattern as it is.

### Solution

In one general aspect of the present invention, there is provided an optic apparatus, the optic apparatus comprising:

an optical pattern unit configured to output an optical pattern; and a conversion unit configured to output the optical pattern by receiving and reducing the optical pattern.

In another general aspect of the present invention, there is provided an optic apparatus, the optic apparatus comprising:

an optical pattern unit configured to align a plurality of lenses in parallel on a same line perpendicular to an optical path; and

an optical conversion unit including a plurality of optical fibers to output an optical pattern of the optical pattern unit by reducing the optical pattern, wherein an area of cross-section at one end of the optical fiber is different from an area of cross-section at the other end of the optical fiber.

### Advantageous Effect

The optic apparatus according to the present invention has an advantageous effect in that a conversion unit configured to reduce or enlarge an image without any distortion is aligned at an output position of an MLA (Micro Lens Array) to allow manufacturing a lens forming the MLA greater than a conventional lens.

Another advantageous effect is that manufacturing of a lens greater in size than a conventional lens enables obtainment of an increased quantity of light over a conventional micro lens to allow an easy alignment of pinhole positioned at a focus of a lens.

Still another advantageous effect is that a conversion unit is mounted to enable an inspection of a target substrate with a higher resolution than that of an MLA.

### BRIEF DESCRIPTION OF THE DRAWINGS

FIG. 1 is a schematic view illustrating an optic apparatus according to the present invention.

FIG. 2 is a schematic view illustrating a conversion unit forming an optic apparatus according to the present invention.

FIG. 3 is a schematic view illustrating an optical system applied by an optic apparatus according to the present invention.

### DETAILED DESCRIPTION

Hereinafter, exemplary embodiments of the present disclosure will be described in detail with reference to the accompanying drawings. In the drawings, the size and relative sizes of layers, regions and/or other elements may be exaggerated or reduced for clarity and convenience.

Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

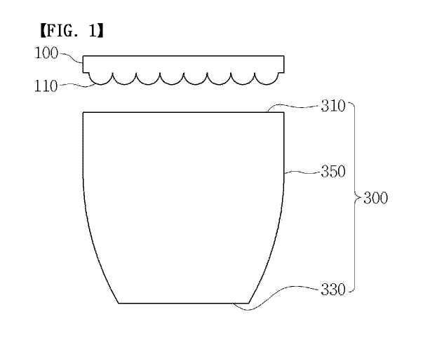

FIG. 1 is a schematic view illustrating an optic apparatus according to the present invention.

The optic apparatus according to the present invention illustrated in FIG. 1 may include an optical pattern unit (100) and a conversion unit (300).

The optical pattern unit (100) may output an optical pattern to an input unit (310) of the conversion unit (300). The optical pattern unit (100) may include a plurality of lenses (110) configured to form a focus toward the conversion unit (300), where the plurality of lenses (110) may be arranged in parallel. The plurality of lenses (110) is same in a direction forming a focus, and when a direction forming the focus is a front surface, the plurality of lenses (110) may be cross-wisely arranged on a same line based on the front surface.

The MLA may be arranged with the plurality of lenses (110) in parallel, whereby a curve of a surface of a target substrate can be inspected when the MLA moves to an axis perpendicular to the target substrate. The size of the lens (110) according to the present invention may be greater than that of each lens (110) of 10 μm˜40 μm forming the MLA. The alignment of lenses is made easier to enable obtainment of more quantity of light than that of the lens (110) forming the conventional MLA by using the greater size of lenses (110). Furthermore, a pinhole (311) formed at a position of focus of the lens (110) can be more easily manufactured as the pinhole (311) is greatly formed in response to the size of the lens (110). The plurality of lenses (110) is formed at a first region of the optical pattern unit (100) where an area of the first region may be formed greater than that of a projected area of the optical pattern outputted from the conversion unit (300), which means that the target substrate can be inspected with higher resolution than that of the MLA.

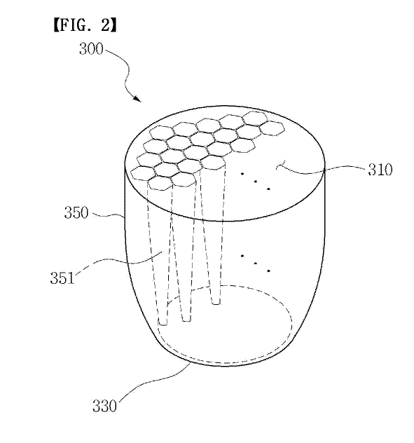

FIG. 2 is a schematic view illustrating a conversion unit forming an optic apparatus according to the present invention.

The conversion unit (300) forming an optical apparatus according to the present invention may include an input unit (310), an output unit (330) and an optical path unit (350).

The input unit (310) may be inputted by an optical pattern outputted from the optical pattern unit (100). The input unit (310) may be formed with a pinhole (311) at a position of focus of the lens (110) forming the optical unit pattern (100). The output unit (330) may output an optical pattern inputted from the input unit (310). An area of the input unit (310) may be greater than that of the output unit (330).

The optical path unit (350) functions to connect the input unit (310) to the output unit (330). The optical path unit (350) gradually tapers off in the size of area from the input unit (310) toward the output unit (330). The optical path unit (350) may include a plurality of optical fibers (351), where each optical fiber (351) may gradually tapers off in terms of cross-sectional area from the input unit (310) toward the output unit (330).

The material of optical fiber (351) may be at least one of plastic, quartz and glass. A diameter of a distal end of input unit (310) side from the optical fiber (351) may be 6 um-25 um. A diameter of a distal end of output unit (330) side from the optical fiber (351) may be 3 μm˜6 μm. No gap exists between optical fibers (351).

When it is assumed that an output surface for outputting light from the output unit (330) is defined as x₁ y₁ plane, a coordinate of a point positioned by a distal end of the optical fiber is defined as (x₁, y₁), an input surface for inputting light into the input unit (310) is defined as x₂ y₂ plane, a coordinate of a point positioned by the other distal end of the optical fiber is defined as (x₂, y₂), then x₁: y₁=x₂: y₂, which means that both distal ends of the optical fiber are positioned at a position of same ratio in consideration of shrinkage (reduction).

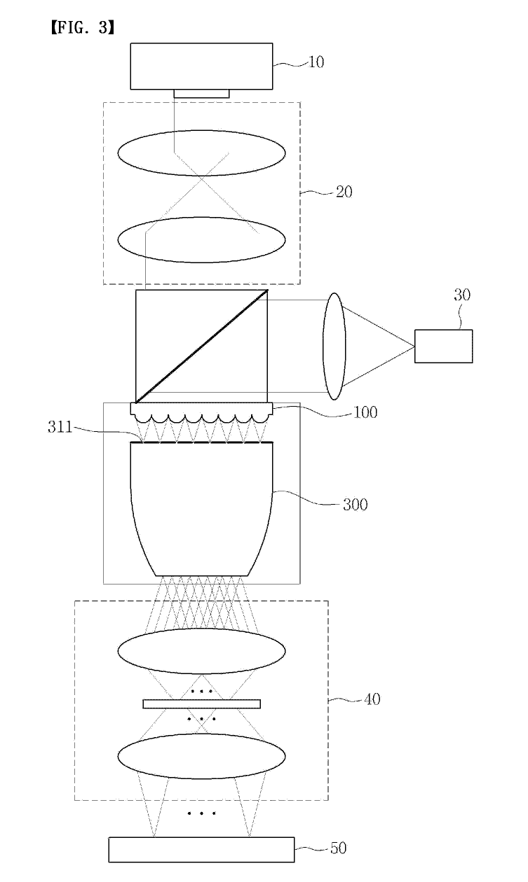

FIG. 3 is a schematic view illustrating an optical system applied by an optic apparatus according to the present invention.

The optical flow illustrated in FIG. 3 may be described as follows: That is, Light generated from an optical source (30) may be aligned as a plane wave by passing through a lens positioned at a front surface of the light source (30). The aligned light may be reflected from a reflective mirror to pass through a lens (110) of the optical pattern unit (100). The light having passed through the optical pattern unit (100) may form an optical pattern to be inputted into a conversion unit (300). The light is now shrunken or reduced through the conversion unit (300), and the outputted optical pattern may pass through an optical system for increasing a focal length to reach a target. The light reflected from the target may in turn pass through the optical system for increasing the focal length, and may pass through the conversion unit (300) and the optical pattern unit (100) in that order. The light having re-passed through the optical pattern unit (100) may be measured by a camera (10) by passing through an image capturing optical system (20).

To wrap up the present invention, the optic apparatus according to the present invention includes an optical pattern unit (100) configured to align a plurality of lenses (110) in parallel on a same line perpendicular to an optical path, and an optical conversion unit (300) configured to include a plurality of optical fibers (351), each optical fiber (351) being different in an area of cross-section at both distal ends.

The above-mentioned optic apparatus according to the present invention may, however, be embodied in many different forms and should not be construed as limited to the embodiments set forth herein. Thus, it is intended that embodiments of the present invention may cover the modifications and variations of this invention provided they come within the scope of the appended claims and their equivalents. While particular features or aspects may have been disclosed with respect to several embodiments, such features or aspects may be selectively combined with one or more other features and/or aspects of other embodiments as may be desired.

1. An optic apparatus, the optic apparatus comprising:
an optical pattern unit configured to output an optical pattern; and a conversion unit configured to output the optical pattern by receiving and reducing the optical pattern.

2. The optic apparatus of claim 1, wherein the conversion unit includes an input unit configured to input the optical pattern outputted from the optical pattern unit, an output unit configured to output the optical pattern, and an optical path unit configured to connect the input unit and the output unit.

3. The optic apparatus of claim 2, wherein an area of the input unit is greater than that of the output unit.

4. The optic apparatus of claim 2, wherein an area of cross-section of the optical path unit gradually decreases from the input unit toward the output unit.

5. The optic apparatus of claim 2, wherein the optical path unit includes a plurality of optical fibers, wherein a cross-sectional area of each optical fiber gradually decreases from the input unit toward the output unit.

6. The optic apparatus of claim 5, wherein each optical fiber is tightly contacted together.

7. The optic apparatus of claim 1, wherein the optical pattern unit includes a plurality of lenses configured to form a focus toward the conversion unit, wherein the plurality of lenses is arranged in parallel.

8. The optic apparatus of claim 7, wherein the plurality of lenses is formed at a first region of the optical pattern unit, and an area of the first region is greater than a projection area of the optical pattern outputted from the conversion unit.

9. An optic apparatus, the optic apparatus comprising:
an optical pattern unit configured to align a plurality of lenses in parallel on a same line perpendicular to an optical path; and
an optical conversion unit including a plurality of optical fibers to output an optical pattern of the optical pattern unit by reducing the optical pattern, wherein an area of cross-section at one end of the optical fiber is different from an area of cross-section at the other end of the optical fiber.
